(19) United States
(12) Patent Application Publication
(10) Pub. No.: US 2024/0422026 A1
(43) Pub. Date: Dec. 19, 2024

(54) COMMUNICATION CIRCUIT

(71) Applicants: INVENTEC (PUDONG) TECHNOLOGY CORPORATION, Shanghai (CN); INVENTEC CORPORATION, Taipei City (TW)

(72) Inventor: Di HAO, Shanghai (CN)

(73) Assignees: INVENTEC (PUDONG) TECHNOLOGY CORPORATION, Shanghai (CN); INVENTEC CORPORATION, Taipei City (TW)

(21) Appl. No.: 18/241,092

(22) Filed: Aug. 31, 2023

(30) Foreign Application Priority Data
Jun. 14, 2023 (CN) 202310708499.0

(51) Int. Cl. H04L 12/40

(52) U.S. Cl. CPC H04L 12/40123; H04L 12/40013; H04L 12/4013; H04L 2012/40215

(57) ABSTRACT

A communication circuit includes: a microcontroller chip, a system basis chip and an ultra-wideband chip. The system basis chip and the ultra-wideband chip are each electrically connected to the microcontroller chip. The microcontroller chip has a Bluetooth radio function. The system basis chip has a plurality of first controller area network pins.

### CROSS-REFERENCE TO RELATED APPLICATIONS

This non-provisional application claims priority under 35 U.S.C. § 119(a) on Patent Application No(s). 202310708499.0 filed in China on Jun. 14, 2023, the entire contents of which are hereby incorporated by reference.

### BACKGROUND

### 1. Technical Field

This disclosure relates to a communication circuit, particularly to a communication circuit having Bluetooth function.

### 2. Related Art

In the past, a microcontroller chip and a Bluetooth chip were used for different functions in the communication circuit, which made the peripheral circuit complex and the production cycle easily affected by the chip supply.

### SUMMARY

Accordingly, this disclosure provides a communication circuit.

According to one or more embodiment of this disclosure, a communication circuit includes a microcontroller chip, a system basis chip and an ultra-wideband chip. The system basis chip and the ultra-wideband chip are each electrically connected to the microcontroller chip. The microcontroller chip has a Bluetooth radio function. The system basis chip has a plurality of first controller area network pins.

In view of the above description, the communication circuit of the present disclosure can simplify the peripheral circuit. And as less chip is used, the impact of chip supply on the production cycle is reduced, and manufacturing costs can also be reduced.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of a communication circuit according to an embodiment of the present disclosure; and

FIG. 2 is a signal connection diagram of a communication circuit according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

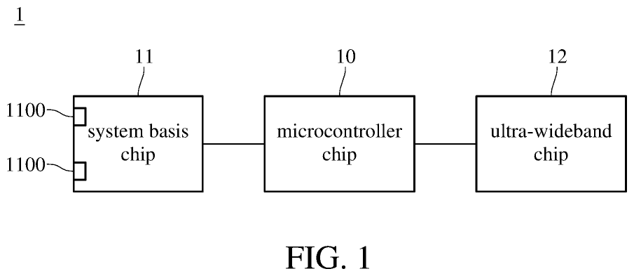

Please refer to FIG. 1 which is a schematic diagram of a communication circuit according to an embodiment of the present disclosure. As shown in FIG. 1, according to one embodiment of the present disclosure, a communication circuit 1 includes a microcontroller chip 10, a system basis chip 11 and an ultra-wideband chip 12. The system basis chip 11 is electrically connected to the microcontroller chip 10, and has a plurality of first controller area network pins 1100. The ultra-wideband chip 12 is electrically connected to the microcontroller chip 10.

The microcontroller chip 10 has a Bluetooth radio function. Specifically, the microcontroller chip 10 may be a KW45 chip and the Bluetooth radio function may be according to Bluetooth version 5.3. The microcontroller chip 10 may have two analog digital pins. The microcontroller chip 10 can have a plurality of second controller area network pins, and can transmit data with the system basis chip 11 through the controller area network protocol and the serial peripheral interface protocol. Further, a plurality of second controller area network pins can be applied to a controller area network with a flexible data rate (Controller Area Network Flexible Data-Rate, CAN FD), which is especially suitable for automotive and industrial applications. In addition, the microcontroller chip 10 can also transmit data with the ultra-wideband chip 12 through the serial peripheral interface protocol.

The system basis chip 11 is configured to implement functions such as voltage regulation, communication and monitoring, and is electrically connected to the microcontroller chip 10 to be controlled by the microcontroller chip 10. Specifically, the system basis chip 11 can be connected to the bus of the controller area network through the plurality of first controller area network pins 1100.

The ultra-wideband chip 12 is configured for ultra-wideband communication.

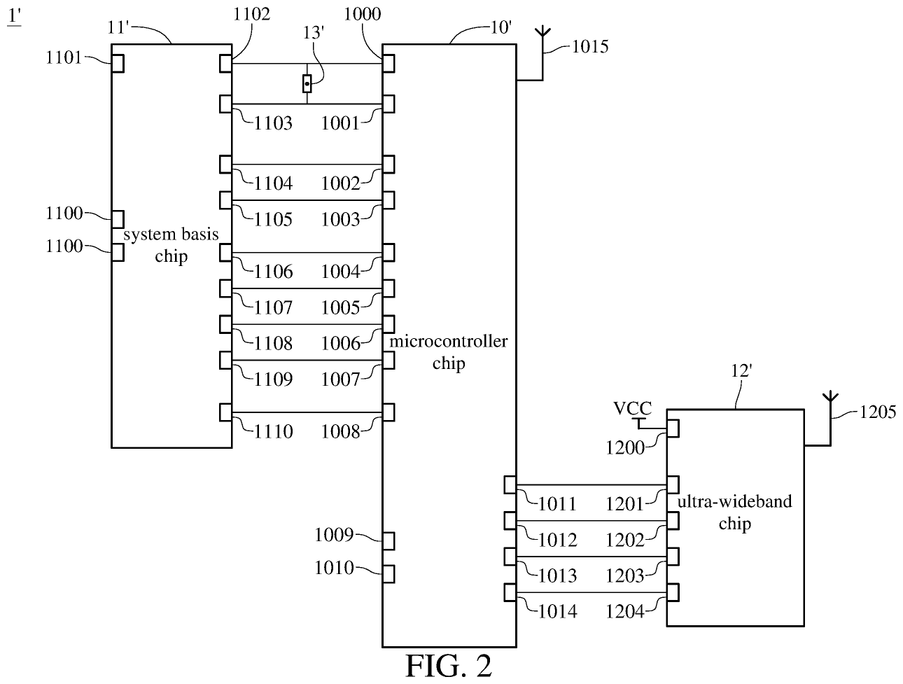

Please refer to FIG. 2 which is a signal connection diagram of a communication circuit according to an embodiment of the present disclosure. As shown in FIG. 2, a communication circuit 1′ includes a microcontroller chip 10′, a system basis chip 11′ and an ultra-wideband chip 12′. The functions of the microcontroller chip 10′, the system basis chip 11′ and the ultra-wideband chip 12′ are respectively the same as those of the microcontroller chip 10, the system basis chip 11 and the ultra-wideband chip 12 shown in FIG. 1. The signal connection relationship among the microcontroller chip 10′, the system basis chip 11′ and the ultra-wideband chip 12′ is described below.

Pins 1000 to 1008 of the microcontroller chip 10′ are configured to be connected to pins 1102 to 1110 of the system basis chip 11′. Pin 1000 is configured to receive electrical power of, for example, 3.3 volts from pin 1102. Pin 1001 is configured to receive a voltage signal from pin 1103. A circuit unit 13′ is included between the above two connections (between the connection of pins 1000 and 1102 and the connection of pins 1001 and 1103). The circuit unit 13′ can be, for example, a circuit in which multiple capacitors and resistors are connected in parallel for filtering. Pin 1002 is configured to receive the controller area network signal from pin 1104. Pin 1003 is configured to output the controller area network signal to pin 1105. Pin 1004 is configured to receive a reset signal from pin 1106 for the reset function. Pin 1005 is configured to receive a first analog digital signal from pin 1107. Pin 1006 is configured to receive a first interrupt signal from pin 1108. Pin 1007 is configured to receive a second interrupt signal from pin 1109. Pin 1008 is configured to receive a serial peripheral interface signal from pin 1110 for data transmission. Pin 1009 and pin 1010 are respectively configured to receive a second analog digital signal and a third analog digital signal.

Pins 1011 to 1014 of the microcontroller chip 10′ are configured to be electrically connected to pins 1201 to 1204 of the ultra-wideband chip 12′. Pin 1011 and pin 1201 are configured to transmit data to each other through the serial peripheral interface protocol. Pin 1012 is configured to transmit a reset signal to pin 1202 for the reset function. Pin 1013 is configured to send a ready signal to pin 1203. Pin 1014 is configured to receive a third interrupt signal from pin 1204.

In addition to the pins mentioned above, the system basis chip 11′ further includes a plurality of first controller area network pins 1100 to be electrically connected to the bus of the controller area network. Pin 1101 is configured to receive voltage of 12 volts to supply power to the system basis chip 11′. The ultra-wideband chip 12′ further includes a pin 1200 for receiving a voltage (such as 3.3 volts). In addition, the microcontroller chip 10′ has a Bluetooth antenna 1015 for Bluetooth communication, and the ultra-wideband chip 12′ includes a ultra-wideband antenna 1205 for ultra-wideband communication.

In view of the above description, the communication circuit of the present disclosure can simplify the peripheral circuit. And as less chip is used, the impact of chip supply on the production cycle is reduced, and manufacturing costs can also be reduced.

What is claimed is:

1. A communication circuit comprising:
a microcontroller chip having a Bluetooth radio function;
a system basis chip electrically connected to the microcontroller chip, and having a plurality of first controller area network pins; and
an ultra-wideband chip electrically connected to the microcontroller chip.

2. The communication circuit of claim 1, wherein the Bluetooth radio function of the microcontroller chip is according to Bluetooth version 5.3.

3. The communication circuit of claim 1, wherein the microcontroller chip has a plurality of second controller area network pins, and the plurality of second controller area network pins perform data transmission with the system basis chip through a controller area network protocol.

4. The communication circuit of claim 3, wherein the plurality of second controller area network pins are applicable for controller area network flexible data-rate.

5. The communication circuit of claim 1, wherein the microcontroller chip communicates with the system basis chip through a serial peripheral interface protocol.

6. The communication circuit of claim 1, wherein the microcontroller chip communicates with the ultra-wideband chip through a serial peripheral interface protocol.

7. The communication circuit of claim 1, wherein the microcontroller chip controls a reset function of the system basis chip through a first reset signal.

8. The communication circuit of claim 1, wherein the microcontroller chip controls a reset function of the ultra-wideband chip through a second reset signal.

9. The communication circuit of claim 1, wherein the microcontroller chip is a KW45 chip.

10. The communication circuit of claim 1, wherein the system basis chip is connected to a bus of a controller area network through the plurality of first controller area network pins.
